(19) United States
(12) Patent Application Publication
(10) Pub. No.: US 2019/0191721 A1
(43) Pub. Date: Jun. 27, 2019

(54) SYSTEM FOR PRODUCING FLATBREAD, AND METHOD FOR THE PROVISION OF SAME

(71) Applicant: Flatev AG, Zürich (CH)

(72) Inventors: Jonas Müller, Pfäffikon (CH); Pamela Vazquez Gutierrez, Zürich (CH); Fabian Sonderegger, Winterthur (CH)

(21) Appl. No.: 16/085,622

(22) PCT Filed: Feb. 22, 2017
(86) PCT No.: PCT/EP2017/054067

§ 371 Date: Sep. 17, 2018

(30) Foreign Application Priority Data
Mar. 16, 2016 (DE) 10 2016 104 887.9

(51) Int. Cl. A21C 11/00; A21C 5/00; A21D 10/04; A21D 8/06

(52) U.S. Cl. CPC A21C 11/006; A21C 5/00; A21B 7/005; A21D 8/06; A21D 10/045

(57) ABSTRACT

A system for producing flatbread, comprising a closed portion capsule (1) that has a pre-shaped dough body (7) arranged therein, preferably an individual portion dough body, consisting of a, preferably, yeast-free dough material on the basis of flour and water and preferably on the basis of wheat flour and water, in order to produce flatbread in a domestic flatbread baking device, with the dough body (7) being shaped. According to the invention, the dough body (7) comprises a dough crust all the way around made of the dough material and enclosing a core that consists of a mass of raw dough.

### BACKGROUND OF THE INVENTION

The invention relates to a system for producing flatbread, comprising a closed portion capsule having a pre-formed, in particular press-formed, dough body disposed therein, preferably a single-portion dough body, made of a preferably yeast-free dough material on the basis of (cereal) flour and water, preferably on the basis of wheat flour and water, for producing flatbread, in particular a tortilla, in a household flatbread baking device by deforming the dough body. Preferably, the dough material can contain a type of flour other than wheat flour and/or oil and/or fat and/or salt and/or additives.

Furthermore, the invention relates to a method for providing (producing) a system comprising a closed portion capsule having a dough body disposed therein.

Moreover, the invention relates to the use of such a system comprising a portion capsule having a dough body disposed therein with a household flatbread baking device, in the course of which the dough body is deformed, i.e. flattened, and a flatbread is baked.

From applicant's WO 2013/124809 A2, a method and a device for producing a flatbread from a dough body is known, said dough body being stored in a portion capsule and, in a household flatbread baking device, being transferred from the portion capsule into a combined deforming and baking device which deforms the dough body into a flatbread, in particular a tortilla, bakes the flatbread and discharges it after baking.

The portion capsule preferably used in the course of the method according to the teaching of the published application has, adjacent to a sealing portion at which a lid film is sealed to a capsule container, a circular groove into which a circular knife of the flatbread baking device can be inserted in order to open the portion capsule, said circular knife not coming into contact with the sticky wheat dough body owing to the circular groove, thus not becoming soiled.

In practice, transferring the dough body from the portion capsule into functional units of the household flatbread baking device, such as a deforming device and a baking device, may prove difficult because wheat doughs, in particular, are sticky and thus tend to adhere to the inside of the portion capsule, in particular after a long storage time of several days, and to the inside of functional units and to transport paths within the household baking device.

From WO 98/04139 A1, it is known for the dough to be partially fried so as to provide a pre-cooked dough-based food product. This is supposed to enable the consumer to finish cooking the final product at home in the form in which it was delivered.

From WO 03/077660 A1, it is known for a dough-based multilayer food product comprising two layers of different materials, which are placed on each other and then rolled in a spiral, to be heated from a single side, more precisely from below, in a continuous oven. The document deals with problems of industrial production; in particular, the aim is to prevent the food products, which already have their final shape, from sticking to baking trays or conveyor belts during industrial production; in particular, the aim is to prevent the food products, which have their final shape, from absorbing an undesirable flavor of contact surfaces.

WO 2014/071300 A1 does not relate to dough bodies, but to the processing of slurries. From the document, it is known for the slurry to be thermally treated in such a manner that it completely gelatinizes and becomes crispy at the outside.

WO 2004/030461 A1 discloses the production of lye-treated baked goods from dough which are heavily browned on the outside.

JP 3150910 B relates to the production of dough-based frozen products.

WO 2004/066751 A1 describes thermal treatment of a food product with steam.

From DE 699 18 075 T2, a method for treating food products is known, wherein, according to the teaching of the document, a dough portion is placed on a fluid-proof conveyor belt and heated at the underside so as to harden the dough portion. Optionally, the top and the longitudinal sides of the dough portion are heated as well. According to the further teaching of the document, the thus treated dough portion can either be processed further immediately by a baking process, or it is alternatively possible, according to the teaching of the document, for the pre-treated dough portion to be temporarily stored in freezing conditions prior to the baking process. Deformation of the dough portion, which is hardened at the edges, prior to the baking process, takes place in neither alternative.

### SUMMARY OF THE INVENTION

Based on the aforementioned state of the art, in particular applicant's WO 2013/124809 A1, the object of the invention is to provide a system comprising a portion capsule having a pre-formed dough body disposed therein, the system ensuring, even in the case of a long storage time in non-freezing conditions, that the dough body does not stick to the inside of the capsule. Moreover, the combination of a portion capsule and a dough body is to be of such a nature that the dough body can be processed without problems in a household flatbread baking device, in particular flattened to a flatbread, i.e. deformed and baked. Furthermore, the object is to provide a method for providing a system of this kind, comprising a portion capsule and a pre-formed dough body packaged therein for producing flatbread.

With regard to the system, i.e. said combination of portion capsule and dough, said object is attained by the features disclosed herein, i.e. by a generic system, in that the dough body has a fully circumferential dough crust made of the dough material, said crust enclosing a core of raw dough. The substantial aspect is that the dough body is a dough body that has yet to be deformed into a flatbread, i.e. does not have the finished flatbread shape which will be formed from the dough body in the household flatbread baking device only. Thus, a dough body within the meaning of the invention is a shaped lump, chunk, or ball which preferably has a defined outer contour and which (despite the crust) can be deformed, in particular flattened, into the flatbread.

With regard to the method, the object is attained by the features disclosed herein, i.e. in a generic method, in that raw, thermally untreated dough on the basis of flour and water, in particular on the basis of wheat flour and water, is provided and (pre-)formed into a dough body in a defined manner, in particular by press forming, wherein during and/or after the forming step, the full circumference of the formed dough body is heated in such a manner that the fully circumferential dough crust forms, which encloses the core of still raw, in particular non-gelatinized, dough, whereupon, in particular after an optional cooling step, the preformed dough body comprising the dough crust is transferred into a portion capsule, and the portion capsule is subsequently closed, in particular hermetically, in particular by sealing a lid film onto a capsule container, which is characterized in particular by a larger mean wall thickness than the lid film.

The system configured and/or provided as above serves to be used with and in a household flatbread baking device, preferably after non-frozen storage, i.e. in the case of a storage at room temperature or in a refrigeration compartment above 0° C., of at least two days, preferably more than 10 days, more preferably more than 30 days, the dough body with the dough crust being removed from the portion capsule in the household baking device and the dough body, which preferably forms a single portion, being transferred, preferably by sliding it, into a deforming device for deforming the dough body into a, preferably single, flatbread by breaking up the dough crust, and the flatbread being baked during and/or after deformation. Deformation takes place in a flattening direction (flatbread thickness direction), preferably from an original thickness of the dough body of more than 1 cm, in particular more than 2 cm, into a flatbread thickness of less than 5 mm, preferably less than 4 mm, in particular between 1 mm and 3 mm. The substantial aspect is that the dough crust is broken up during deformation, i.e. loses its enveloping function, and, preferably during deformation, is at least partially covered by the raw dough located within the dough crust, meaning it is pushed into said raw dough.

The aforementioned use shall also be deemed disclosed within the scope of the present disclosure as an independent method, which shall be claimable as an independent invention. The method relates to the production of a flatbread in the manner described above in a household flatbread baking device, using a dough body which has a fully circumferential dough crust and which is removed from a portion capsule of a system according to the invention and whose dough crust is broken up in the deforming device of the household flatbread baking device as described above and preferably worked at least partially into the raw dough (core). Accordingly, the dough crust has an only temporary protective function, i.e. a storage and transport function.

Advantageous embodiments of the invention are indicated in the dependent claims. Any and all combinations of at least two of the features indicated in the description, in the claims and/or in the figures shall fall within the scope of the invention.

In order to avoid redundancies, features disclosed in accordance with the device and as objects shall be claimable in accordance with the method as well. Likewise, features disclosed in accordance with the method shall be deemed disclosed and claimable in accordance with the device.

With regard to a dough body packaged in a, preferably hermetically, closed portion capsule, the object is based on the idea of providing the dough body made of a preferably yeast-free dough material (dough) on the basis of flour and water, in particular on the basis of wheat flour and water, and formed (preformed) from dough, preferably by press forming, with a dough crust, in particular by applying dry heat, said dough crust forming on an outer portion (peripheral layer) of the dough material by heat application, the dough crust enclosing a core of raw dough, i.e. dough that is substantially thermally untreated and has only been exposed to temperatures below 60° C., preferably below 50° C., more preferably below 40° C. and even more preferably below 30° C. Especially preferably, the thermal treatment, as will be explained later, is performed in such a manner that at least a center (geometrical center) of the core does not heat up during the thermal treatment. As will be explained later, it is especially preferred for the dough crust to not be browned by the thermal treatment, i.e. to substantially not differ from the raw core dough in terms of the degree of browning, because the dough crust will be intentionally destroyed and at least partially worked into the raw dough during the subsequent deforming process in the household flatbread baking device, at which stage it is supposed to optically stand out as little as possible. Accordingly, the dough crust intentionally has an only temporary protective function, which, one the one hand, prevents the dough body from adhering to an inner wall of the portion capsule, which is preferably a single-portion capsule, i.e. in particular to the inside of a capsule lid and to the inner wall of a capsule container closed by the lid, even after it has been stored in non-freezing conditions for several days; instead, during the unpacking process within the household flatbread baking device, the dough body slides out of the then open portion capsule, in particular without any raw dough residue remaining in the capsule. Furthermore, the dough body, which, in its state protected by the dough crust, is transported, without leaving any residue on functional units or transport paths of the household flatbread baking device, to a deforming device, which is preferably configured as a combined deforming and baking device, in order to be deformed, i.e. flattened, in the deforming device into a plane flatbread shape, in particular into a tortilla shape, which is substantially two-dimensional compared to the dough body. It is knowingly accepted that by breaking up the dough crust, the raw dough comes into direct contact with the deforming device and/or with the baking device; corresponding non-stick coatings may be provided on the corresponding functional unit of the household flatbread baking device (in particular tortilla baking device).

In a particularly preferred manner, the provided dough crust allows the dough body to keep its advantageous properties, in particular a non-sticking property, across its entire minimum shelf life of preferably 30 days, even more preferably 40 days, in particular preferably 50 days, even more preferably 60 days, when stored in non-freezing conditions.

When the portion capsule is configured according to the invention with the dough body having a dough crust disposed therein, special coating of the portion capsule, which is costly and which, moreover, would not effectively prevent sticking for the duration of the shelf life of the dough portion, preferably more than 40 days, can be omitted. Also, coating of the raw dough with flour would have no long-lasting effect. Another advantage is that additives reducing stickiness in the dough, which preferably contains wheat flour, can be omitted.

As mentioned, the dough body preferably is a single portion for producing a single flatbread, in particular a single tortilla, while multiple flatbreads can of course be produced consecutively with the baking device when using multiple systems. For this purpose, the dough body preferably has a weight between 20 g and 60 g, preferably between 30 g and 50 g, even more preferably between 30 g and 40 g and/or a volume from a value range between 20 cm³ and 60 cm³, preferably between 25 cm³und 50 cm³, even more preferably between 30 cm³ and 45 cm³. As explained before, according to the invention, the shape of the dough body does not correspond to the shape of the finished food product, but needs to be deformed into a flatbread by breaking up the dough crust. Preferably, according to ICC Standard No. 169, the measured viscosity of the core, i.e. of the raw dough within the dough crust, is between 1.700 BU and 2.500 BU (Brabender Units), in particular between 1.900 BU and 2.400 BU, in particular preferably between 2.100 BU and 2.300 BU. Accordingly, the raw dough is a highly viscous sticky mass in contrast to the texture of the crust, which is not sticky and has a significantly lower moisture content than the core. In the dough crust, in contrast to the core, the thermal treatment has produced a hardened gluten network, any Maillard-reaction phenomena preferably being suppressed as much as possible through suitable (preferably little) temperature control/selection. Preferably, the result of the measurement according to ICC Standard No. 169 is between 400 and 800 BU with respect to the dough crust.

Preferably, the hardness of the dough crust according to ISO 11036:1994 is between 300 and 400 Newton with respect to a penetration depth of 1.5 mm and/or the hardness of the dough is between 200 and 300 Newton with respect to a penetration depth of 3 mm. Preferably, the measurement is performed using a texture measuring device TA.XTplus with a 45° conical probe according to the P45C Perspex method by Stable Micro Systems.

Preferably, the texture of the core according to DIN EN ISO 5530-1:2013 is between 470 and 520 FU (Farinograph Units).

As previously indicated, the portion capsule preferably comprises a capsule container which is made of plastic and/or metal and vat-shaped, in particular. If it is made of plastic, the capsule preferably comprises a barrier layer, in particular an EVOH layer, against humidity and/or oxygen. The capsule container can be injection-molded or deep-drawn or produced on the basis of any other plastic processing technology. The use of laminates comprising at least one plastic layer, which may also contain a metal layer, if required, is possible as well. It is also possible for the capsule container to be produced entirely from metal, such as aluminum, in particular as a deep-drawn part. In any event, the capsule container surrounds the dough body and is closed by a lid film, which is preferably sealed to the capsule container, in particular at a collar disposed at the opening. Preferably, a groove into which a circular knife can be inserted to open the lid film is provided radially within the sealing surface; however, owing to the configuration of the dough body with the dough crust, this can be omitted because there is no extensive risk of soiling the knife. Preferably, the material thicknesses of the capsule container and of the film differ, preferably by at least 200 μm. A typical material thickness of a plastic capsule container is between about 0.1 mm and 0.5 mm, whereas the material thickness of a lid film is preferably about 0.1 mm. The plastic capsule container is preferably produced by deep-drawing a plastic film which, prior to deep drawing, has a material thickness of 0.55 mm, for example. Of course, variations thereof can be implemented as well.

In order to further extend the shelf life of the dough body in the portion capsule, an embodiment of the invention advantageously envisages for the dough body in the portion capsule to be surrounded by protective gas.

Since the dough crust of the dough body has its function merely during storage in the portion capsule and on the short way to the deforming device in the flatbread baking device, it is preferably only as thick as necessary, in particular so as to be able to work it into the raw dough as completely as possible so that the dough body crust itself will no longer appear in the produced flatbread. Hence, the dough crust preferably has a mean layer thickness from a value range between 0.5 mm and 4 mm, preferably between 0.8 mm and 3 mm, in particular preferably between 0.9 mm and 2.5 mm, even more preferably between 1.0 mm and 2.1 mm.

Preferably, a moisture weight percentage of the dough crust is between 6 and 20 w %, preferably between 10 and 16 w %, more preferably between 12 and 14 w %, and/or a moisture weight percentage of the core is between 28 and 50 w %, preferably between 30 and 40 w %, even more preferably between 34 and 36 w %. It has proven particularly advantageous if the moisture weight percentage (moisture content) of the core is significantly higher than that of the crust, in particular by at least 8 w %, even more preferably by at least 15 w %, even more preferably by at least 25 w %, in particular preferably by at least 30 w %. The moisture content is preferably measured according to DIN EN ISO 712:2009.

The dough body, which does not have the shape of the finished product, i.e. of the flatbread, extends along three spatial directions, its smallest extension in one spatial direction, i.e. its smallest diameter, preferably being at least 1 cm, preferably at least 2 cm, even more preferably at least 3 cm. Overall, it is advantageous if the smallest diameter (independently from the absolute measure) is at least 20 times larger, preferably at least 30 times larger than the layer thickness of the aforementioned dough crust.

Since the dough body is a preferably lump-shaped dough body and not an already flat flatbread shape, an embodiment of the invention envisages for the extension along each spatial axis to be no more than 10 times as large, preferably no more than five times as large, even more preferably nor more than three times as large as the respective extension of each of the two other spatial axes in a three-dimensional Cartesian coordinate system with the spatial axes X, Y, Z, which are disposed at right angles to one another. With regard to the specific shape, there are different options. It is particularly advantageous if the dough body is formed to be at least partially, preferably fully, congruent in shape to the inner volume of the portion capsule, i.e. has a contour that corresponds to the inner contour of the portion capsule on an identical or smaller scale. It is particularly advantageous if the dough body is shaped like a spherical segment, frustoconical, cuboid, or spherical.

In the course of the method according to the invention for providing a closed portion capsule with a dough body disposed therein, it is envisaged first to provide a raw dough, in particular thermally untreated dough, on the basis of flour and water, in particular on the basis of wheat flour and water, even more preferably without added yeast, which has been described above in connection with the explanation of the combination of a portion capsule and a dough body. The dough is preferably homogeneous.

Preferably after or during a portioning step, which can be based on weight and/or volume, the dough body is formed from the raw dough, in particular by press-forming using a corresponding forming tool.

As will be explained later, according to the invention, the full circumference of the dough body is heated by means of a preferably employed forming tool and/or after forming of the dough body, for example, so that the fully circumferential dough crust forms, which surrounds the core of still raw dough. Preferably after an optional cooling step, the dough body with the dough crust is transferred into the portion capsule, which is then closed, in particular with the inclusion of protective gas, in particular by sealing a lid onto a capsule container.

The heating step is preferably not a frying step because the temperatures occurring are too high and would lead to an undesirable browning of the dough crust. Preferably, the heat is a dry heat.

The heating step can advantageously be realized by means of a contact heater, which is in contact with the dough body, in particular by means of a heatable forming tool for forming the dough body as mentioned, or alternatively by means of a downstream contact heater, which, even more preferably at least in sections, preferably across the full circumference, has the contour of the dough body. In addition or preferably as an alternative to the use of a contact heater, thermal treatment by thermal irradiation by means of an infrared heater has proven advantageous. It preferably comprises a plurality of infrared radiators disposed in the circumferential direction around the dough portion so as to thermally irradiate the dough portion with heat directly from multiple sides or across the full circumference; if applicable, heating of the dough body from all sides in order to form the dough crust may also be realized in a convection oven.

The advantage of heating by means of the forming tool is that the method is particularly effective and no separate heating step is required. The advantage of providing an infrared radiator is that it is an effective and cost-saving method. Preferably, the heating is not performed above a flame, such as a gas flame, because ash residue is undesirable. As mentioned, the heating step is also preferably not a frying step.

As explained before, it is especially preferred for production of a uniform fully circumferential crust if the dough body is heated by means of a contact heater for crust formation. The contact heater is configured in such a manner that it comes into contact with and heats the dough body at not only one side, such as the underside, but at multiple sides, in particular across the full circumference. For this purpose, an embodiment of the invention envisages for the contact heater to comprise multiple heating elements, such as two shells, which can be displaced relative to each other and which can be and are moved together to form a circumferentially closed heating structure in order to preferably contact and heat the full circumference of the dough body. It is possible, for example, to provide two vat-shaped heating elements ore one vat-shaped heating element and a lid element for closing the vat. By contact heating at multiple sides, in particular across the full circumference, uniform crust formation (i.e. a crust having the same thickness at multiple sides, in particular across its entire circumference) is ensured. It is particularly preferred if the contact heater is simultaneously configured as a forming tool, in particular a pressing tool for forming and pressing the dough body into a desired shape. In this case, accordingly, the dough body is not only heated for crust formation but also brought into the desired shape by means of the contact heater and the forming tool, in particular the press-forming tool.

It has proven particularly advantageous if the dough body is accommodated between the multiple, in particular exactly two, heating elements and a force is exerted on it for pressing, in particular during a first period of time during the heating step. It is preferred, in particular, if said pressing is reduced or stopped after a certain time, in particular after a duration of less than 2 s, more preferably less than 1 s and/or preferably more than 0.1 s, even more preferably between 0.3 s and 0.7 s, ins particular 0.5 s, thus allowing steam to escape through the at least one gap occurring between at least two heating elements or pressing elements.

Preferably, the heating elements are configured in such a manner that they define an inner space which is filled by the dough body and which corresponds to the inner shape of the portion capsule. It is particularly preferred if the heating elements are heated to a temperature from a range between 150° C. and 250° C., in particular preferably between 160° C. and 230° C., even more preferably to 180° C., in order to produce the crust.

After the pressing has been released, the dough body is preferably heated once more via the heating elements until crust formation is complete. Favorable experiences were had with a method in which the pressing was released after about 0.5 s and generated steam can escape, crust formation being complete after a contact heating time of about 20 s.

It is particularly preferred for the heating elements to be made of stainless steal at least at their contact surface coming into contact with the dough body.

There are different options regarding the configuration of the actuating mechanism for relative displacement of the heating elements, in particular of the heating/press-forming elements. In the case of a contact heater, it is preferable in general if a mobile part and a part disposed stationary relative thereto are provided so that only a single heating element has to be displaced in order to open and close a heating or baking cavity. Preferably, displacement happens pneumatically, while hydraulic and/or electric-motor displacement drives can generally be realized as well.

In a particularly preferred manner, the heating step is performed by modulating a duration and a temperature in such a manner that for forming the dough crust, the temperature of the dough portion is higher than 60° C., preferably at least 65° C., more preferably higher than 80° C. at the outer circumference and is no higher than 60° C., preferably no higher than 50° C., even more preferably no higher than 40° C. starting from a depth of no more than 4 mm, i.e. from 4 mm at the latest, preferably of no more than 3 mm, i.e. from 3 mm at the latest, even more preferably of no more than 2 mm, i.e. from 2 mm at the latest, in particular preferably of no more than 1 mm, i.e. from 1 mm at the latest, to be measured perpendicular from the outer circumference. In other words, the temperature should quickly, in particular exponentially, decrease from the outside to the inside. It is particularly preferred for the temperature of the raw dough, i.e. of the core, to be lower than 30° C. at a depth of 5 mm at the latest, preferably of 4 mm, and/or lower than 25° C. at a center of the core.

In a particularly preferred manner, the temperature at the inside of the crust is greater than or equal to 65° C. after the heating process because the gluten will start to denature at a temperature of about 65° C.

It is particularly preferred if the heating step is performed in such a manner, in particular by selection of a lowest possible heating temperature, that preferably no visible browning or, at the most, a very slight browning of the dough body and of its dough crust occurs and/or that substantially no Maillard reaction or, at the most, only a minor Maillard reaction occurs at the dough crust. To this end, the heating step is preferably carried out for a relatively short duration of preferably less than 40 s, even more preferably of less than 30 s, in particular preferably between 10 s and 28 s, even more preferably between 15 s and 25 s, even more preferably of 20 s. In the preferable case that a contact heater is used, it is advantageous for the contact heater to have a temperature between 170° C. and 250° C., in particular preferably between 180° C. and 220° C., in particular preferably of 200° C. at the contact surfaces of its heating elements that come into contact with the dough portion. By carrying out the heating step for a short period of time in combination with a steam atmosphere forming in the interior (cavity) of a contact heater due to water evaporating out of the surface of the dough portion, browning reactions can be avoided surprisingly well or at least be reduced to a minimum.

As explained above, the temperature of the dough crust is controlled in such a manner that as little color differences as possible result between the dough crust and the core (i.e. the raw dough material) so that the original dough crust components and core components can no longer be discerned, if possible, in the finished flatbread after mixing in the household device. Preferably, the colors of the dough crust and of the core (core material) differ only marginally, if at all, in the CIELAB color space with the Cartesian base coordinates L*, a*, b* according to EN ISO 11664-4:2011. Preferably, the dough crust and/or the core have a color in the CIELAB color space that is defined by L* between 60 and 85 and/or a* between -0.25 and 2.5 and/or b* between 15 and 30. It has proven particularly advantageous if the dough crust has a value L* between 60 and 80, and/or a value a* between −0.25 and 2.5, and/or a value b* between 15 and 30 in the CIELAB color space. It is especially preferred if the color of the core has a value L* between 75 and 85, and/or a value a* between 0.15 and 0.6 and/or a value b* between 20 and 25 in the CIELAB color space.

The difference between the color of the dough crust and the color of the core is preferably no greater than between 0 and 40 with respect to the lightness coordinate L* and/or between 0 and 3.3 with respect to coordinate a* and/or between 0 and 20 with respect to coordinate b*.

As mentioned above, it is preferred for the dough body provided with the dough crust to be cooled, in particular on a conveyor belt, preferably to an outer temperature of less than 60° C., preferably less than 50° C. even more preferably less than 40° C., in particular preferably less than 30° C., especially preferably less than 20° C., even more preferably less than 12° C., in particular preferably less than 4° C., before it is transferred into the portion capsule.

As mentioned in the beginning, the invention also relates to the use of a portion capsule with a dough body located therein, comprising a dough crust surrounding the raw dough, for producing a flatbread, in particular a single flatbread, in a household flatbread baking device, in which the dough body of the portion capsule is removed, in particular automatically, such as actuated by motor or manually, from the portion capsule and is transferred, for example and preferably in a sliding manner because of the dough crust being provided, into a deforming device for deforming the dough body by breaking up the dough crust into a, preferably the, flatbread, and the flatbread is baked either in a baking device downstream of the deforming device or in a combined deforming and baking device.

As already indicated, the corresponding method for producing the flatbread using a household flatbread baking device, which can be configured as described in WO 2013/124809 A2, for example, but does not have to be configured specifically like that, shall be deemed disclosed and claimable.

The method comprises the following steps, wherein the portion capsule and/or the dough body are disclosed as in the scope of the present disclosure, in particular as in the claims:
a) opening the portion capsule and transferring the dough body with the dough crust into a deforming device, in particular by sliding at least in sections,
b) deforming the dough body by means of the deforming device by breaking up the dough crust, the deformed product preferably having a thickness of less than 5 mm, preferably less than 4 mm, in particular preferably between 1 mm and 3 mm after deformation,
c) baking the flatbread during and/or after deformation. Preferably, a single portion of a flatbread is produced and, if applicable, multiple single portions of a flatbread are produced consecutively in the course of the method.

Preferably, the dough body is deformed (flattened) and the dough crust is broken up by pressing forces of less than 3000 N and/or greater than 500 N, especially preferably by pressing forces from a range between 800 N and 2200 N, in particular preferably between 1300 N and 2000 N.

### BRIEF DESCRIPTION OF THE DRAWINGS

Other advantages, features and details of the invention are apparent from the following description of preferable embodiments and from the drawings.

FIG. 1: is a flow chart of a preferable variation of a method according to the invention for providing a portion capsule with a dough body packaged therein,

FIG. 2: is an illustration showing a portion capsule with a dough body,

FIG. 3: is a diagram showing a preferable temperature distribution within the dough body after a heating step, and

FIG. 4: is an illustration showing a contact heater which is configured as a press forming tool for carrying out the forming and heating step to shape the dough body and to form the crust.

### DETAILED DESCRIPTION

In the figures, identical elements and elements having the same function are marked with the same reference signs.

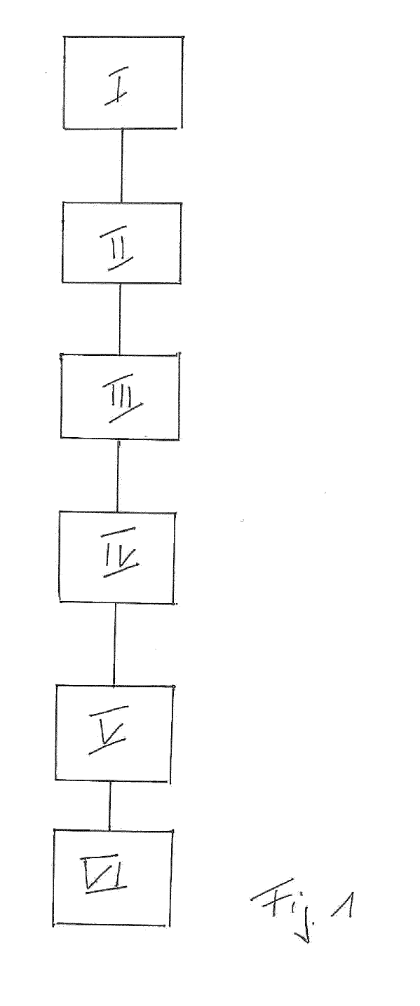

In the course of a preferable process flow, which is illustrated in FIG. 1, homogenous raw dough on the basis of water and flour, in this case wheat flour and water, is provided in step I.

In step II, the raw dough is portioned into individual portions, which have a weight between 35 g and 45 g in this specific embodiment.

In step III, the portioned individual portions are formed into a lump-shaped (defined) lump congruent in shape to the inner contour of a portion capsule by press-forming by means of a press-forming tool, and in step IV, the dough body is heated, whereby a fully circumferential dough crust which encloses the core of still raw dough is formed. The heating step IV is carried out in such a manner that substantially no browning of the dough crust occurs. The temperature at the inside of the dough is 65° C. in the embodiment at hand and drops steeply in the direction of a geometrical center of the dough body.

In step V, the previously heated dough body is cooled, and in step VI, it is transferred into a portion capsule and the portion capsule is closed. Specifically, the dough body is received in a portion capsule, which is then hermetically closed by sealing of a lid film.

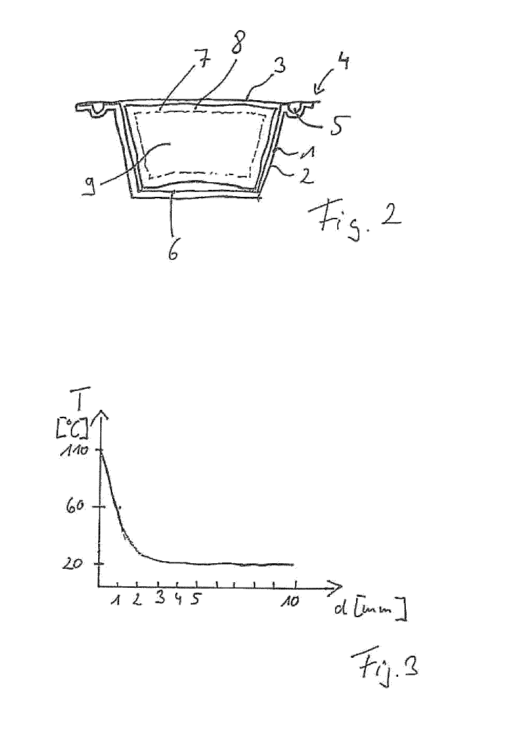

FIG. 2 shows a portion capsule 1 comprising a vat-shaped capsule container 2, which is closed by a lid film 3. The lid film 3 is sealed in a circumferential sealing portion 4, in this case outside of a circumferential groove, for example, which can be omitted, if applicable.

An inner volume 6 of the portion capsule holds a pre-formed dough body 7 which consists entirely of a dough material, the dough body 7 having a fully circumferential dough crust which is formed by the dough material and which encloses a core of raw dough 9. After transport and storage, the dough body 7 is removed from its package in a household baking device, where it is deformed into a flatbread shape by breaking up the dough crust 8 and baked.

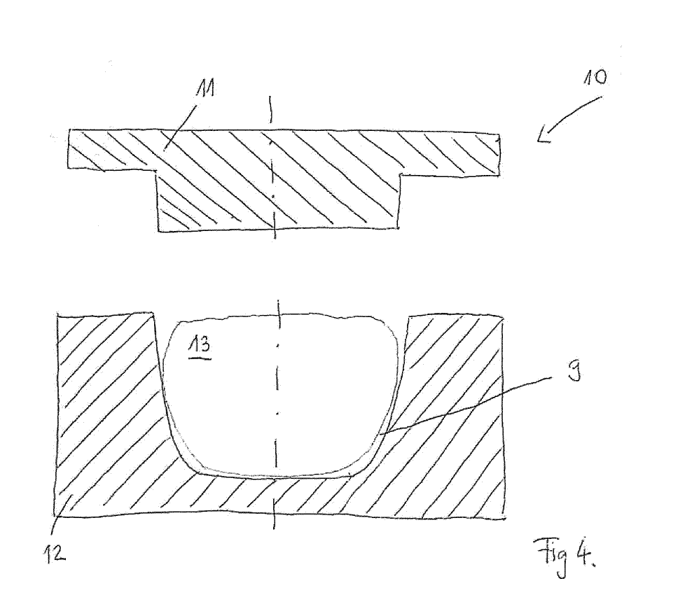

FIG. 3 shows, by way of example, the temperature distribution and the temperature curve from the outside to the inside in a dough body 7 after the heating step. As can be seen, the maximum temperature on the outer side, i.e. at the outer circumference of the dough body, is 110° C. or just below and then drops sharply, a temperature level of approximately 20° C. prevailing after a distance d of about 3 mm to 4 mm from the outer circumferential surface in this specific embodiment. In FIG. 4, a preferable embodiment of a contact heater 10 for carrying out the heating step c) to form the crust is shown by way of example. The contact heater 10 shown is also configured as a press-forming tool in order to carry out method step b), i.e. to form the dough body 7 by press-forming in the case at hand.

As can be seen in FIG. 4, the contact heater 10 is composed of multiple parts and, in this specific embodiment, comprises first and second heating elements 11, 12, wherein the heating elements 11, 12 are displaceable relative to each other pneumatically in the embodiment at hand by displacing a triangular heating element 11, which is located at the top in the drawing plane, relative to a vat-shaped stationary heating element 12. In the case at hand, the heating elements 11, 12 are made mainly of stainless steel and are heated to a temperature of 180° C.

Once a dough portion 7 has been introduced into a cavity 13 provided by heating element 12, the heating elements 11, 12 are displaced toward each other by active displacement of heating element 11, whereby the dough 9 is fully contacted and shaped and simultaneously heated and a uniform fully circumferential dough crust 8 forms. At the same time, the heating elements 11, 12 exert a pressing force on the dough 9 to form the dough body 7. In FIG. 4, a contour of the dough 9 prior to the actual press-forming process is shown; after the pressing process, that is after the pressing has been released in the case at hand, the shape of the resulting dough body 7 corresponds to the inner contour of the heating elements 11, 12. The pressing is released after a defined period of time, such as 0.5 s in the case at hand; this causes a circumferential gap to be formed between the heating elements 11, 12, through which steam can escape, while the heating elements 11, 12 continue to be in contact with and heat the dough body 7 after release of the pressing. The crust formation process is completed after a total heating duration of 20 s in the case at hand, whereupon the dough body 7 with the dough crust 8 is removed from the cavity 13, the triangular heating element 11 first having to be lifted to do so, of course.

### REFERENCE SIGNS

1 portion capsule

2 capsule container

3 lid film

4 sealing portion

6 inner volume of the portion capsule

7 dough body

8 dough crust

9 dough

10 contact heater

11 heating element

12 heating element

13 cavity

1-19. (canceled)

20. A system for producing flatbread, comprising a closed portion capsule (1) having a pre-formed dough body (7) disposed therein, made of a dough material on the basis of flour and water, for producing flatbread in a household flatbread baking device or flatbread baking device by deforming the dough body (7), wherein the dough body (7) is removed or unpacked from the portion capsule (1) in the household flatbread baking device or flatbread baking device, wherein the dough body (7) has a fully circumferential dough crust (8) which is made of the dough material, wherein said dough crust is formed in the dough material by heat application and which encloses a core made of raw dough, wherein a mean layer thickness of the dough crust (8) is in a value range between 0.5 mm and 4.0 mm, wherein a moisture weight percentage of the dough crust (8) is between 6 and 20 w %, and/or wherein a moisture weight percentage of the core is between 28 and 50 w %, and/or wherein a moisture weight percentage of the core is higher than a moisture weight percentage of the dough crust (8) by at least 8 w %, and a smallest diameter of the dough body (7) is at least 20 times larger than the mean layer thickness of the dough crust (8).

21. The system according to claim 20, wherein the portion capsule (1) has a capsule container (2), which surrounds the dough body (7), and wherein the capsule container (2) is closed by means of a lid film (3).

22. The system according to claim 20, wherein the dough body (7) in the portion capsule (1) is surrounded by protective gas.

23. The system according to claim 20, wherein a mean layer thickness of the dough crust (8) is in a value range between 0.8 mm and 3.0 mm.

24. The system according to claim 20, wherein a moisture weight percentage of the dough crust (8) is between 10 and 16 w %, and/or wherein a moisture weight percentage of the core is between 30 and 40 w %, and/or wherein a moisture weight percentage of the core is higher than a moisture weight percentage of the dough crust (8) by at least 15 w %.

25. The system according to claim 20, wherein a smallest diameter of the dough body (7) is at least 30 times larger than the mean layer thickness of the dough crust (8).

26. The system according to claim 20, wherein the dough body (7) extends along three Cartesian spatial axes x, y, z, which are disposed at right angles to each other, and wherein the extension along each spatial axis is no more than ten times, the respective extension along each of the two other spatial axes.

27. The system according to claim 20, wherein the color of the dough crust (8) and/or of the core in the CIELAB color space with the Cartesian base coordinates L*, a*, b*is defined by L* between 60 and 85 and/or a* between −0.25 and 2.5 and/or b* between 15 and 30 according to EN ISO 11664-4:2011, and/or wherein the color of the dough crust (8) in the CIELAB color space with the Cartesian base coordinates L*, a*, b* is defined by L* between 60 and 80 and/or a* between −0.25 and 2.5 and/or b* between 15 and 30 according to EN ISO 1164-4:2011, and/or wherein the color of the core in the CIELAB color space with the Cartesian base coordinates L*, a*, b* is defined by L* between 75 and 85 and/or a* between 0.15 and 0.6 and/or b* between 20 and 25 according to EN ISO 11664-4:2011, and/or wherein the color of the dough crust (8) differs from the color of the core in the CIELAB color space with the Cartesian base coordinates L*, a*, b* by no more than one or by more than one of the following base-coordinate values: L* between 0 and 40 and/or a* between 0 and 3.3 and/or b* between 0 and 20.

28. A method for providing a system according to claim 20, comprising a closed portion capsule (1) having a dough body (7) disposed therein for being processed into flatbread by deforming the dough body (7) in a household flatbread baking device or flatbread baking device, the method comprising the steps of:
a) providing raw dough (9) on the basis of flour and water;
b) forming a dough body (7) from the raw dough (9);
c) during and/or after step b), heating the full circumference of the dough body (7), thereby producing the fully circumferential dough crust which encloses the core of still raw dough (9), wherein a mean layer thickness of the dough crust (8) is in a value range between 0.5 mm and 4.0 mm;
d) transferring the dough body (7) with the dough crust (8) into a portion capsule (1) and closing the portion capsule (1).

29. The method according to claim 28, wherein prior to or by means of the forming step b), a dough portion to be formed is portioned.

30. The method according to claim 28, wherein the heating step c) is carried out by means of a contact heater and/or by means of an infrared heater.

31. The method according to claim 30, wherein the contact heater (10) has multiple heating elements (11, 12) which can be displaced relative to each other and which, during the heating step c), are in contact with and heat multiple sides of the dough body (7).

32. The method according to claim 31, wherein after a predetermined period of time, during the heating step c), the heating elements (11, 12) are displaced relative to each other in such a manner that steam escapes.

33. The method according to claim 31, wherein the heating step c) is performed in such a manner that a steam atmosphere is formed at the outer circumference of the dough body (7) within the contact heater.

34. The method according to claim 29, wherein the heating step c) is performed in such a manner that the temperature of the dough body (7) is greater than 60° C., at the outer circumference and is no more than 60° C. at a depth of no more than 4 mm to be measured perpendicular to and starting from the outer circumference.

35. The method according to claim 29, wherein the heating step c) is carried out in such a manner that the die color of the dough crust (8) and/or of the core in the CIELAB color space with the Cartesian base coordinates L*, a*, b* is defined by L* between 60 and 85 and/or a* between −0.25 and 2.5 and/or b* between 15 and 30 according to EN ISO 11664-4:2011, and/or in such a manner that the color of the dough crust (8) in the CIELAB color space with the Cartesian base coordinates L*, a*, b* is defined by L* between 60 and 80 and/or a* between −0.25 and 2.5 and/or b* between 15 and 30 according to EN ISO 1164-4:2011, and/or in such a manner that the color of the core in the CIELAB color space with the Cartesian base coordinates L*, a*, b* is defined by L* between 75 and 85 and/or a* between 0.15 and 0.6 and/or b* between 20 and 25 according to EN ISO 11664-4:2011, and/or in such a manner that the color of the dough crust (8) differs from the color of the core in the CIELAB color space with the Cartesian base coordinates L*, a*, b* by no more than one or by more than one of the following base-coordinate values: L* between 0 and 40 and/or a* between 0 and 3.3 and/or b* between 0 and 20.

36. The method according to claim 29, wherein the dough body (7) is cooled prior to being transferred into the capsule.

37. A use of a system according to claim 20, comprising a household flatbread baking device or flatbread baking device in which the dough body (7) with the dough crust (8) is removed from the portion capsule (1) and the dough body (7) is transferred into a deforming device for deforming the dough body (7) into a flatbread by breaking up the dough crust, and the flatbread is baked during and/or after deformation.

38. A method for producing a flatbread using a household flatbread baking device or flatbread baking device by employing a system according to claim 20, the method comprising the steps of:
opening the portion capsule (1) and transferring the dough body (7) with the dough crust (8) into a deforming device of the household flatbread baking device or flatbread baking device,
deforming the dough body (7) by means of a deforming device by breaking up the dough crust (8),
baking the flatbread during and/or after deformation.
